(19) United States
(12) Patent Application Publication
(10) Pub. No.: US 2013/0085786 A1
(43) Pub. Date: Apr. 4, 2013

(54) SYSTEM, METHOD, AND COMPUTER PROGRAM PRODUCT FOR DYNAMIC MESSAGING

(71) Applicant: AMERICAN INTERNATIONAL GROUP, INC., New York, NY (US)

(72) Inventors: Andrew Longtine, Plover, WI (US); Sara Stroik, Stevens Point, WI (US)

(73) Assignee: AMERICAN INTERNATIONAL GROUP, INC., New York, NY (US)

(21) Appl. No.: 13/632,568

(22) Filed: Oct. 1, 2012

Related U.S. Application Data
(60) Provisional application No. 61/541,579, filed on Sep. 30, 2011.

(51) Int. Cl. G06Q 40/08

(52) U.S. Cl. 705/4

(57) ABSTRACT

Dynamic messaging systems and methods include a non-transitory, tangible computer-readable storage medium bearing instructions for performing dynamic messaging steps. A request message is received from a partner site based on a travel product selected by a customer from the partner site. The request message is analyzed using a dynamic messaging service (DMS) module operating within the computer system. A travel insurance product is identified and a message-content is selected from a database based upon information received from the partner site concerning the selected travel product. A quote for the identified travel insurance product is generated. The quotation and the message-content are compiled into a return message, which is communicated to the partner site for display to the customer.

### CROSS-REFERENCE TO RELATED APPLICATIONS

This patent application claims the benefit of priority to U.S. Provisional Patent Application No. 61/541,579, filed on Sep. 30, 2011, and entitled “System, Method, and Computer Program Product for Dynamic Messaging,” which is incorporated in its entirety herein by this reference.

### TECHNICAL FIELD

This patent disclosure relates generally to a system, method, and computer product for dynamic messaging. More particularly, the disclosure relates to a system, method, and computer product for generating dynamic messaging in connection with the marketing of products, such as insurance products.

### BACKGROUND

Online advertising is a form of promotion that uses the Internet for delivering marketing messages to attract customers. Examples of online advertising include contextual advertisements on search engine results pages, banner advertisements, rich media advertisements, social network advertisements, interstitial advertisements, online classified advertisements, and others. One major benefit of online advertising is the ready publishing of information and content to recipients geographically distributed over large areas and at various times.

Depending on the type of products or services being offered by online advertisers, the time, place, content, and placement of the advertisement can determine its effectiveness with potential customers. Affiliate marketing, for example, is a form of online advertising where advertisers place campaigns with publishers whose products and services are related or complementary to those advertised.

Recently, online advertising has been tailored to the content that a prospective customer views or for which a prospective customer searches. In this type of advertising, for example, online advertising can be targeted based on a user's current viewing content or past content.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### BRIEF SUMMARY

Various aspects of the disclosure describe a computer-implemented system, a method and anon-transitory, tangible computer-readable storage medium bearing instructions for dynamic messaging. In one aspect, a system for dynamic messaging includes a physical computer-readable medium including a dynamic messaging program and a processor adapted to execute the dynamic messaging program contained on the physical computer-readable medium.

In one arrangement, a system for dynamic messaging includes a physical computer-readable medium having computer-executable instructions stored thereon which comprise a dynamic messaging program having a message-content determining module and a product price calculating module. A web-enabled interface is operably arranged with the processor and is adapted to exchange information with a partner site over the interne. A data storage device is operably arranged with the processor. The data storage device contains a plurality of message-contents relating to a plurality of travel insurance products. The product price calculating module includes computer executable instructions adapted to calculate a price quotation for a travel insurance product based upon information received from the partner site through the web-enabled interface where the information relates to a travel product selected on the partner site by a customer. The message-content determining module includes computer executable instructions adapted to select, based upon the information relating to the travel product selected on the partner site by the customer, at least one message-content related to the travel product from the message-contents stored in the data storage device. It should be understood that reference herein to a “product,” “travel product,” “travel insurance product,” or the like includes a product offering, a service offering, or a combination of both a product and a service offering.

In another aspect, a method for dynamic messaging is described. Travel product information regarding a travel product selected by a customer on a web platform of a partner is received through a network including a web-enabled interface. A processor is employed to execute computer executable instructions stored on a tangible computer-readable medium to perform steps for dynamic messaging. A travel insurance product is identified from a set of travel insurance products based upon the travel product information received. A quotation is generated for the identified travel insurance product. A message-content is selected from a set of message-contents stored in a data storage device based upon the travel product information received. A message packet that includes the quotation for the identified travel insurance product and the selected message-content is generated. The message packet is transmitted through the network to the partner site.

In another arrangement, a method is described for providing dynamic messaging to advertise a travel insurance policy to a customer having selected a travel product from a partner site. A request message is received in a computer system. The request message contains information indicative of parameters of the travel product selected by the customer. The request message is analyzed using a processor of the computer system to execute a dynamic messaging service (PMS) module stored on a physical computer-readable medium. The DMS module identifies a travel insurance product to advertise from a set of travel insurance products based upon at least one parameter of the travel product selected by the customer and selects a message-content from a database of the computer system based on at least one parameter of the travel product selected by the customer. The processor is used to execute a pricing module stored on a physical computer-readable medium to generate a price quotation for the identified travel insurance product. The processor is used to execute instructions stored on a physical computer-readable medium to compile a return message containing at least the selected message-content and the price quotation. The processor is used to transmit the return message through a web-enabled interface to the partner site. The return message is communicated from the computer system of the travel insurance provider to the computer system of the partner site for display to the customer.

In still another aspect, a non-transitory, tangible computer-readable storage medium is described. The storage medium bears instructions for dynamic messaging, which, when executing on one or more computing devices, perform dynamic messaging steps. A travel insurance product is identified from a set of travel insurance products based upon information received from a partner through a network. The information includes at least one parameter of a travel product selected by a customer on a web platform. A quote for the identified travel insurance product is generated. A message-content is selected from a database of the computer system based on at least one parameter of the travel product selected by the customer. A return message containing at least the quote and the message-content is compiled.

Further and alternative aspects and features of the disclosed principles will be appreciated from the following detailed description and the accompanying drawings. As will be appreciated, the principles related to dynamic messaging disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic view of an exemplary embodiment of system architecture in keeping with principles of the present disclosure.

FIG. 2 is a block diagram of an exemplary embodiment of a dynamic messaging application.

FIG. 3 is a flow diagram that illustrates an exemplary embodiment of a method of providing a dynamic messaging service.

FIG. 4 is a flow diagram that illustrates an exemplary embodiment of a method of providing a dynamic messaging service.

### DETAILED DESCRIPTION OF MESSAGING EMBODIMENTS

Systems, methods, and computer program products for dynamic messaging are described herein. In the following detailed description, references are made to the accompanying drawings that form a part hereof, and in which are shown by way of illustration, specific embodiments or examples. These embodiments may be combined, other embodiments may be utilized, and various changes may be made without departing from the spirit or scope of the present disclosure. The following detailed description is therefore not to be taken in a limiting sense.

Aspects of the present disclosure relates to embodiments of a computer-implemented messaging system that dynamically adapts to a particular product that a customer is reviewing for purchase, or has already purchased, such that sales of related products may be offered to the customer through messages generated by a dynamic messaging application stored upon a non-transitory, tangible computer-readable medium in operable arrangement with a processor adapted to execute the dynamic messaging application. In one embodiment, the dynamic messaging application is stored upon a non-transitory, tangible computer-readable medium and operably arranged with a provider's dynamic messaging processor. The dynamic messaging processor is communicatively connected, such as, through a web-enabled interface, to one or more servers of partner entities that conduct business in related products and services. The provider's dynamic messaging processor is adapted to execute the dynamic messaging application. In embodiments, the dynamic messaging application comprises a computer program product residing on a non-transitory, tangible computer readable medium having a messaging module and a calculating module with a plurality of instructions stored thereon which, when executed by the provider's dynamic messaging server, cause the dynamic messaging application to perform steps associated with identifying one or more products and/or services offered for sate by the provider based upon information received from the partner site, calculating a quotation for the identified product(s)/service(s), identifying a message-content based upon information received from the partner site, and transmitting the appropriate return message-content which can include the quotation information.

In one exemplary embodiment, a provider of travel insurance products cooperates with at least one partner who operates a website offering travel products for purchase by e-commerce customers. The travel insurance provider can operate the dynamic messaging application to generate advertising content for one or more of the provider's products complementary to the travel product the customer is viewing on, or purchasing from, the partner's website. The provider can transmit the dynamically-generated advertising content through a web-enabled interface to the partner's processor for display on a webpage of the partner's website. In this way, the provider can generate a message containing a quote for a travel insurance product that is tailored to the particular travel product(s) purchased/viewed by a customer of the partner site(s). Moreover, the provider can advertise the quoted travel insurance product and customize the content of the advertisement to the individual parameters of each customer via a message generated by the dynamic messaging application.

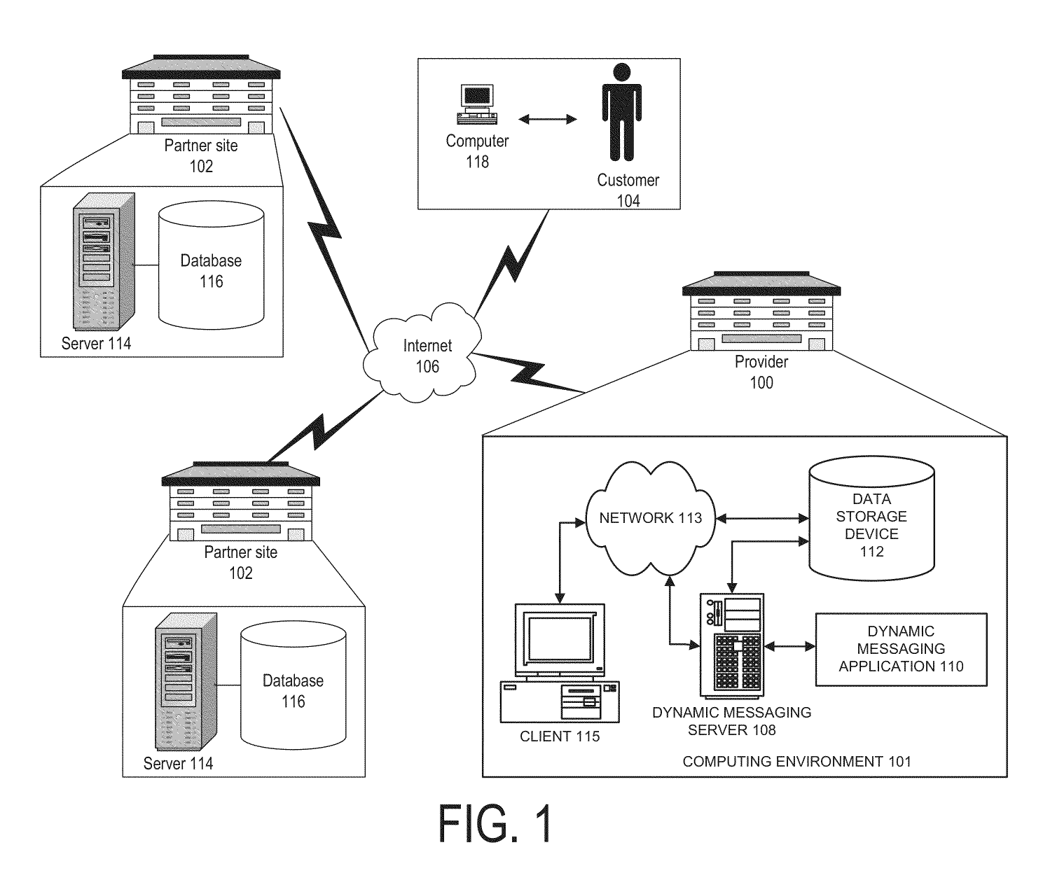

Turning now to the Figures, there is shown in FIG. 1, an embodiment of a computer-implemented system for automatically providing dynamic messaging with product pricing. A provider 100 operates a computing environment 101 that includes a dynamic messaging processor or server 108 operating a dynamic messaging application 110 stored upon a non-transitory, tangible computer-readable medium and a data storage device 112 operatively connected together via an internal network 113. The provider 100 is communicatively connected with one or more partner sites 102 (two shown) and a customer 104 through an external network 106, such as the Internet.

The dynamic messaging processor 108 can act as a web server to provide access o an internet-based web platform that includes the dynamic messaging application 110. In some embodiments, the dynamic messaging server 108 can be adapted to host a web site, to execute enterprise applications, to deliver web pages and other content upon request to clients, and to receive content from clients. A web client, such as the partner sites 102, for example, can be connected to the dynamic messaging processor 108 through a network connection (e.g., the Internet 106, Intranet, LAN, WAN and the like).

The dynamic messaging processor 108 can generally include any computational node including a mechanism for servicing requests from a client for computational resources, data storage resources, or a combination of computational and data storage resources. Furthermore, the dynamic messaging processor 108 can generally include any system that can host the dynamic messaging application 110. The dynamic messaging processor 108 can generally include any component of an application that can receive input from a web client, process the input, present the input to the dynamic messaging application 110, and present output from the processor 108 to the web client and/or the data storage device 112. The dynamic messaging processor 108 can also generally include any component of an application that can process data, interact with the data storage device 112, and execute logic for the dynamic messaging application 110.

The dynamic messaging processor 108 can use an authentication server in order to validate and assign proper permissions to authorized users of the system. A permission database can store web user credentials and permissions specific to each user. The dynamic messaging processor 108 can be outfitted with a firewall such that requests originating from outside the computing environment pass through the firewall before being received and processed at the dynamic messaging processor 108.

The dynamic messaging application 110 comprises a computer program product residing on anon-transitory, tangible computer readable medium having a calculating module and a dynamic messaging module comprising a plurality of instructions stored thereon which, when executed by the dynamic messaging processor 108, cause the processor 108 to perform steps associated with dynamic messaging, including: calculating a price quotation for at least one product offered by the provider based upon input received from an associated partner site 102 relating to a product selected by the customer on the partner site 102; selecting at least one message-content from the database 112, which stores a plurality of message-contents, based upon the input received from the partner site regarding the partner product; and generating a message packet that includes the calculated price quotation and the selected message-content(s). The application 110 can be any suitable computer-implemented application for processing information exchanged with the partner sites 102 via a web platform such as those known to one of ordinary skill in the art.

The dynamic messaging application 110 contains computer executable instructions adapted to exchange information in the form of data with the database 112. The dynamic messaging application 110 can include a graphical user interface which can facilitate the input of message-content and pricing information into the dynamic messaging application 110.

The architecture solution of the dynamic messaging application 110 is flexible and scalable to include additional pricing information for different products offered by the provider and to include additional message-contents for the various products offered by the provider. For example, the dynamic messaging application 110 can be scaled to include additional types of products of the provider 100, additional types and classes of message-content, and the like. The resulting requirements may include diverse inputs, dynamic labels, and additional calculations which can be incorporated into the dynamic messaging application 110 by one of ordinary skill in the art. Any suitable computer-readable storage medium can be utilized, including, for example, hard drives, floppy disks, CD-ROM drives, tape drives, zip drives, flash drives, optical storage devices, magnetic storage devices, and the like.

The database or data storage device 112 can generally include any type of system for storing data in non-volatile storage. This includes, but is not limited to, systems based upon: magnetic, optical, and magneto-optical storage devices, as well as storage devices based on flash memory. and/or battery-backed up memory.

The data storage device 112 can comprise a central message repository that is adapted to store the message-contents and price quotations both by product and by partner. The message-contents can be classified and categorized by partner and by product. The messages can be accessible through a utility access module of the dynamic messaging application 110. The central message repository can also store user credentials for functions, such as, message-content creation, replacement, revision, deletion, activation, and deactivation, for example. The central message repository can store information relating to which user performed various functions with respect to a particular message-content, including the time and date the particular user performed such action.

The computing environment 101 can include a client 115 communicating with the dynamic messaging processor 108 through the internal network 113. The client 115 can be used to host a utility interface in the form of a graphical user interface of the dynamic messaging application 110. The graphical user interface can be adapted to facilitate the input of information into the dynamic messaging application 110 and the display of outputs from the dynamic messaging application 110. The client 115 can comprise at least one input device. The client can generally include any node on a network including computational capability and including a mechanism for communicating across the network.

In one embodiment, the client 115 hosts an application front end of the dynamic messaging application 110. The application front end can generally include any component of the dynamic messaging application 110 that can receive input from the partner sites 102 or the client 115, communicate the input to the dynamic messaging application 110, receive output from the dynamic messaging application 110, and present the output to the partner sites 102 and/or the client 115. In one embodiment, the application front end can be a stand-atone system.

The network 113 can generally include any type of wired or wireless communication channel capable of coupling together computing nodes. Examples of a suitable network include, but are not limited to, a local area network, a wide area network, or a combination of networks.

As can be appreciated, the computing environment 101 of the provider 100 can include a number of computer systems, which generally can include any type of computer system based on: a microprocessor, a mainframe computer, a digital signal processor, a portable computing device, a personal organizer, a device controller, or a computational engine within an appliance. For example, the server 108 and related systems may be implemented in one or more electronic devices that are located in one or more locations.

In addition to the components discussed above, the computing environment 101 of the provider can further include one or more of the following: a host server or other computing systems including a processor for processing digital data; a memory device coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

The partner sites 102 can act as a web client that interface with the web platform of the provider 100. For example, the partner sites 102 can use a web client to receive information from, and to transmit information to, the dynamic messaging application 110 operating on the provider's computing environment 100 as described in greater detail below.

The partner sites 102 can include one or more partner web servers 114 adapted to host a website, to execute enterprise applications, to deliver web pages upon request to clients, and to receive content from clients. The partner web server(s) 114 can be adapted to exchange information with a respective database 116 and the provider's dynamic messaging server 108. As one of ordinary skill would appreciate, additional components and systems can cooperate with and/or be communicatively connected to the systems shown, but have been omitted for

The partner sites 102 can provide a partner web platform that offers one or more products or services for sale to the customer 104. For example, in one embodiment, the partner sites 102 comprise travel sites that set travel products, such as airline tickets, hotel services, rental car services, and the like, either directly or indirectly on behalf of another entity. The provider 100 is a seller (or a seller's representative) that sells support products or related products and/or services to those offered by the partner sites 102. For example, the partner sites 102 of the illustrated embodiment offer travel-related products and/or services, and the provider 100 may provide travel insurance and assistance products, such as: refunds for cancelled tickets, lost luggage assistance, travel medical insurance, lost documentation assistance for international travelers, weather-related travel occurrences, and other products and services that are related to the travel products and/or services sold by the partner sites 102. It should be understood that reference herein to a “product,” “travel product,” “travel insurance product,” or the like includes a product offering, a service offering, or a combination of both a product and a service offering.

During operation, the customer 104 can access one of the partner sites 102 through the internet 106 via a personal computer 118 or an equivalent device, such as a smart-phone, internet-enabled handheld device and so forth. When the customer 104 has elected to purchase a particular travel-related product from one of the partner sites 102, the partner web server 114 of the particular partner site 102 can compile and transmit to the dynamic messaging server 108 of the provider 100 a message containing information for at least one of a plurality of data fields relating to the product purchased. Examples of the type of travel product information that can be transmitted to the dynamic messaging server 108 include: the type of travel arrangements made, the customer's travel origin and destination(s), the itinerary, and other information. This message can be sent to the dynamic messaging server 108 in any appropriate form, such as a message in Extensible Markup Language (XML) format, for example.

After receiving the message, the dynamic messaging server 108 can execute instructions in the dynamic messaging application 110 to store the message information in the database 112, identify at least one product or service offered for sale by the provider 100 applicable to the customer's selected travel-related product/service from the partner site 102, generate one or more quotes for at least one identified provider product/service based on the identified travel insurance product(s)/service(s), and select one or more message-contents from a plurality of message-contents based upon the information received from the partner site relating to the travel product the customer selected on the partner site. The dynamic messaging server 108 can execute instructions in the dynamic messaging application 110 to compile a return-message containing the quote(s) and the selected message-content(s) and transmit the return message to the partner's web server 114 so that the content of the return-message is provided, for example, in a web page sent to the customer's computer 118 via the partner web platform of the partner site 102. A direct connection between the customer's computer 118 and the provider's server 108 is not required.

The various message-contents that can be transmitted to the customer 104 via the customer's computer 118 are stored in the provider's database 112. These message-contents are retrieved from the database 112 by the dynamic messaging application 110 and are sent to the customer 104 as will be described in more detail hereinafter.

In embodiments, the return-message transmitted by the dynamic messaging server 108 can include one or more message-contents that are customized to the particular itinerary of the customer 104, such as expected weather and other considerations that may be useful when considering whether travel insurance purchase is desired. In one embodiment, the dynamic messaging server 108 can send the return-message more than once to the customer 104 via the partner site 102, each time with a different message-content. Alternatively, the dynamic messaging server 108 can send a single return-message accompanied by a plurality of message-contents that are configured to cycle through an on-screen display of the partner's web page displayed on the customer's computer 118 while the customer is reviewing and completing the travel product transaction on the partner site 102.

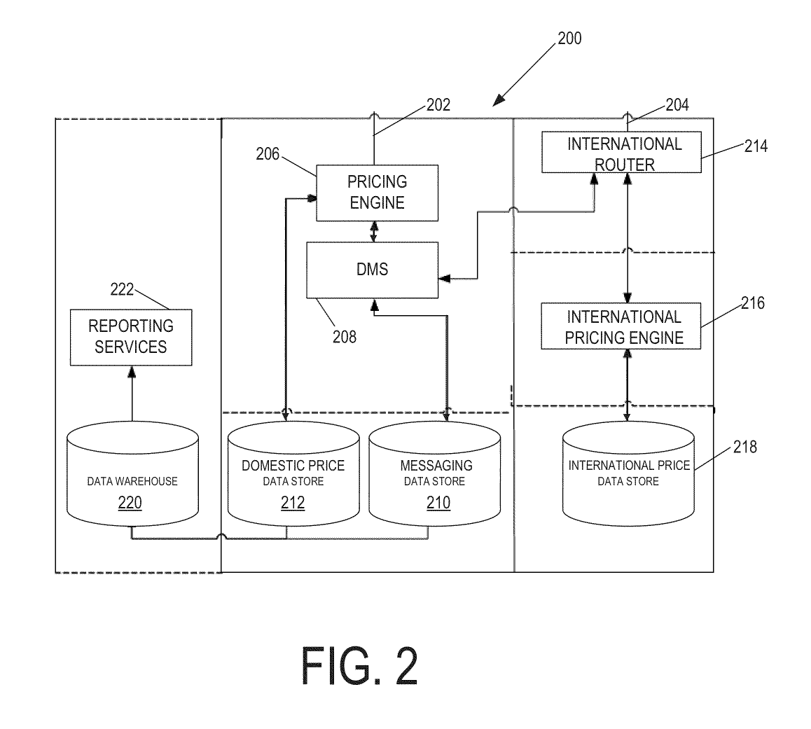

Referring to FIG. 2, a block diagram of one embodiment for a dynamic messaging application 200, such as the dynamic messaging application 110 (FIG. 1). In the illustrated embodiment, the dynamic messaging application 200 is adapted to receive incoming messages from domestic and foreign partner sites through domestic and international channels 202, 204, respectively, such that appropriate quotations for the provider's domestically-offered products and internationally-offered products can be generated. Accordingly, a domestic partner site communication channel 202 and an international partner site communication channel 204 are adapted to convey information to the dynamic messaging application 200 respectively from external domestic partner sites and external foreign partner sites, and also to transmit information from the dynamic messaging application 200 back to the corresponding partner sites and/or customers.

The dynamic messaging application 200 can include a pricing engine 206 and a dynamic messaging service (DMS) module 208. The dynamic messaging application 200 is adapted to determine one or more applicable travel insurance products/services offered by the provider based on information received from a partner site relating to a product offered by the partner.

The pricing engine 206 is adapted to generate a quote for each applicable provider product/service identified by the dynamic messaging application 200 as matching criteria for being related to the information received for the provider product. In some embodiments, the pricing engine 206 can use pricing information stored in a suitable storage device, such as a domestic price data store 212, for example, to generate the price quote for each identified provider product/service. In embodiments, the pricing engine 206 can use a predetermined pricing algorithm to calculate a price quotation for each identified provider product/service which uses information received from the partner site relating to the product offered by the partner.

The pricing information determined at the pricing engine 206 can be provided to the DMS module 208. The DMS module 208 is adapted to control the number, type and content of the message-content(s) provided to the customer along with the quotation(s) generated at the pricing engine 206 based on various parameters. In one arrangement, these parameters can be varied to customize the message-content provided to the customer based on the particular considerations that are applicable to the customer's itinerary. For example, the date or season of the intended travel can be used to determine various environmental considerations, such as travelling to an island during hurricane season, which can prompt a message-content suggesting that a weather-related travel insurance product should be considered by the customer.

The message-contents can be classified by the parameters that apply to the selection of a particular message-content. The classifications of the message-contents and the message-contents themselves can be stored and retrieved in a messaging data store 210. Similarly, various parameters for use when compiling appropriate quotations can be stored in the price quotation data store 212. Information in the messaging data store 210 can be selectively stored and retrieved through the DMS module 208. Similarly, information in the price quotation data store 212 can be selectively stored and retrieved through the pricing engine 206. The data stores 210, 212 can generally include any type of system for storing data in non-volatile storage, including, but not limited to, systems based upon: magnetic, optical, and magneto-optical storage devices, as well as storage devices based on flash memory and/or battery-backed up memory.

In the illustrated embodiment, the domestic channel 202 can be associated with the pricing engine 206, which is adapted to generate quotes for domestic products in response to receiving particular travel information for products purchased by customers domestically. For example, when a customer purchases a travel product, such as an airline ticket on a domestic partner site, the domestic partner site can send a message as previously described through the domestic channel 202 to the dynamic messaging application 200. The message can contain information about the purchased product, such as the type of travel insurance product that is associated with the customer's travel product, the origin, destination and time/date information relative to the customer's travel product.

The dynamic messaging application 200 is adapted to handle requests from foreign customers that are used to generate quotes for products/services sold in international markets. Accordingly, the international channel 204 can be associated with an international router 214, which communicates with the DMS module 208. The international router 214 can be in communication with an international pricing engine 216, which is adapted to generate quotes for international products in response to receiving particular travel information for products purchased by customers internationally. The international pricing engine 216 can be configured to generate quotes that are in accordance with local currency, rules and regulations at the location of each international customer. As with the domestic products, the international pricing engine 216 is configured to store and retrieve information in a data store 218. The data store 218 includes rules and other information for pricing international products.

When a quote is generated, whether by the domestic pricing engine 206 or the international pricing engine 216, a message or a family of messages having at least one message-content can be generated by the DMS module 208 to accompany each particular quote. The messages from the DMS module 208 can be appended or otherwise associated with a particular quote to form a message packet, which is transmitted back to the partner site 102 via the appropriate communication channel 202, 204 from which the original message was received. From there, the message packet containing the quote(s) and the message-content(s) to the customer 104 can be relayed to the customer 104 via the partner site 102.

The messaging data store 210, the domestic price quotation data store 212, and the international price quotation data store 218 can be connected to a data warehouse 220 that is adapted to store and retrieve information from the data stores 210, 212, 218. A reporting services module 222 of the dynamic messaging application 200 can be connected to the data warehouse 220 and adapted to selectively monitor data and compile reports, such as statistical information on the amount of usage of the dynamic messaging application 200 and the like. In one embodiment, the reporting services module 222 further provides pre-configured and/or ad hoc reports relating to the outputs of the dynamic messaging application 200. An output device, which can comprise a printer or a display monitor, for example, can be used to communicate to a user information generated by the reporting services module 222 of the dynamic messaging application 200.

In addition to the components discussed above, a hardware implementation of the dynamic messaging application 200 can further include one or more of the following: a host server or other computing systems including a processor for processing digital data; a memory device coupled to the processor for storing digital data; an input digitizer coupled to the processor for inputting digital data; a dynamic messaging application program stored in the memory and accessible by the processor for directing processing of digital data by the processor; a display device coupled to the processor and memory for displaying information derived from digital data processed by the processor; and a plurality of databases.

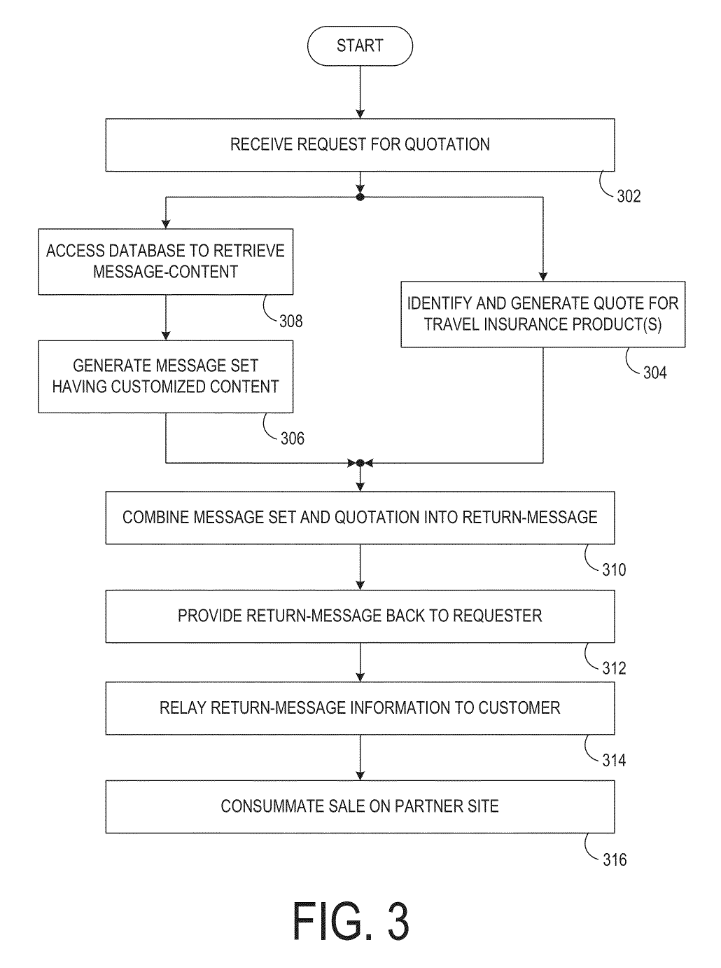

Referring to FIG. 3, a flow chart illustrating steps of an embodiment of a method of operating a dynamic messaging system in accordance with principles of the present disclosure is shown. The process can be initiated at 302 with the receipt of a request for quotation. The request for quotation at 302 may be generated, for example, when a customer accessing a partner site 102 with which the provider 100 cooperates has purchased a particular travel product, has selected a particular travel product for possible purchase or for additional information about the particular product, or has displayed a webpage containing an assortment of related travel products, for example. In the illustrated embodiment, the request for quotation at 302 is received automatically from the partner site without a specific command from the customer. The request for quotation at 302 can contain sufficient information (1) to identify one or more applicable travel insurance products/services attic provider 100 that can be purchased by the customer 104 and that pertain to the associated product of the partner site and (2) to generate a quotation for the same. For instance, the request in an illustrated embodiment includes data fields for product type, origin, destination, and travel dates.

This and other information may be used to identify one or more applicable travel insurance product(s) and generate a quote for each of the same at 304. The generation of the quote may be performed by a pricing engine interfacing with a ratings and product database, for example, the pricing engines 206, 216 shown in FIG. 2. Sequentially or in parallel with generating quotation information at 304, the information from the request at 302 can be used to generate a message set having a customized message-content at 306. The message set generation at 306 can be accomplished by the dynamic messaging application accessing a database at 308 to retrieve message-content that applies to one or more values in the information fields of the request for quotation, such as, the particular product, dates, origin, and/or destination information provided in the illustrated embodiment.

The quotation information generated at 304 and the message-content(s) retrieved at 308 may be combined at 310 into a return-message. The combination may be accomplished as a single packet of information or may alternatively be constructed to form an information string of packets. The return-message from 310 is transmitted to the requester at 312, which in the illustrated embodiment may be a partner site through which a customer is transacting business and from which the request is received at 302.

After the return message has been transmitted to the partner site at 312, the customer may elect to purchase the travel insurance product that was quoted at 304. While the customer may be considering purchasing the travel insurance product, one or more messages that were included in the message-content retrieved at 308 can be relayed by the partner site for display on the webpage being displayed on the customer's screen at 314. The message-content can comprise soliciting the customer's election to purchase the travel insurance product(s) offered by the provider. During this time, one or more individual messages may dynamically rotate through an interface, banner, or other display mode on the webpage displayed on the customer's screen from a server operating at the partner site.

In the event the customer elects to purchase one or more of the quoted travel insurance product(s) of the provider, any purchase prompted by the messages displayed at 314 may be consummated between the partner site and the customer at the partner site at 316. The purchase may be based on the quote generated at 304 and provided to the partner site at 312. in another embodiment, a webpage of the provider can be displayed on the customer's computer interface upon selecting a quoted travel insurance product for purchase. The customer can complete the purchase of the selected travel insurance product from this or a succession of web pages generated by the provider's web server.

In addition to the functionality of the system and method described thus far, the DMS module 208 as shown in FIG. 2 can, in some embodiments, include or be capable of additional functionality that augments its operational capability and flexibility. In some embodiments, for example, the DMS module 208 can include a randomization routine which is adapted to select one message-content from a set of message-contents using a randomization algorithm upon receipt of a request from a partner site. The DMS module 208 is adapted to return the randomly-selected message-content to the partner site for display. Examples of suitable message-contents for travel insurance products include:

Message-content 1—Don't travel alone. Choose us for insurance that travels with you.

Message-content 2—Take cover! Be sure to include Trip Insurance.

Message-content 3—Travel prepared. We recommend including Travel Insurance to cover your pre-paid and non-refundable expenses.

Message-content 4—Heard about the bug going around? Purchase insurance today to cover your trip investment.

Message-content 5—Want to feel more confident booking your trip? Trip Insurance can make any scenario more manageable, especially away from home.

Message-content 6—Ready for the unexpected? You can be with 24/7 Travel Insurance.

Message-content 7—Cover your Investment. Insurance allows you to cover your pre-paid and nonrefundable expenses.

Message-content 8—Crystal ball broken? If you can't see the future, travel insurance is your best move.

Message-content 9—The unexpected can o Tag before or during your trip. Include travel insurance for 24/7 assistance.

Message-content 10—Travel Insurance can provide coverage for the unexpected before and during your trip.

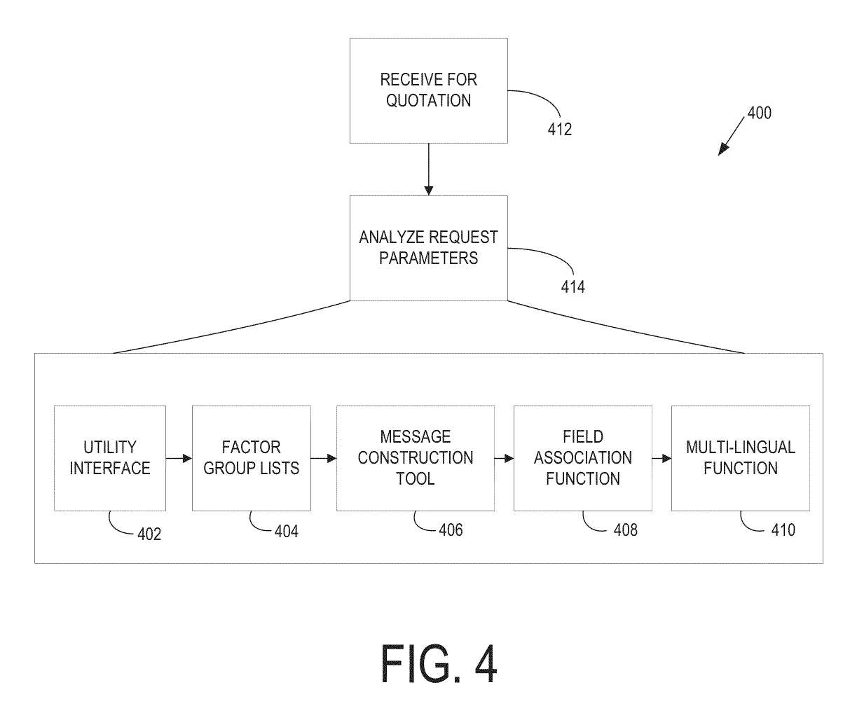

A functional block diagram of one embodiment of a DMS module 400 is shown in FIG. 4. As shown, the DMS module 400 includes various sub-modules that are adapted to carry out specialized functions. In the illustrated embodiment, the DMS module 400 includes a utility interface 402, factor group lists 404, a message construction tool 406, a field association function 408, and a multilingual function 410. The DMS module 400 further includes a module for receiving a request for quotation 412 and a module for analyzing request parameters 414. In other embodiments, the DMS module can include additional or different sub-modules.

When a request for quotation is received at the DMS module 400, the information contained in the request is made available to the various sub-modules through the receive-for-quotation module 412 and the analyze-request-parameters module 414. The receive-for-quotation module 412 can be adapted to receive and route requests from partner sites as well as activate the DMS module 400 to process the request and return a message to the requesting partner site. The request, as previously described, can contain information suitable for matching the product of interest from the partner site to a related travel insurance product offered by the provider. Examples of suitable information include the type of travel product of interest from the partner site, the origin and destination of the customer's itinerary, and the timing of the customer's travel. This information can be extracted into appropriate parameters by the analyze-request-parameters module 414. Thereafter, this information can be used by the various sub-modules to compile an appropriate return message-content.

The utility interface 402 allows users to create, replace, update, and delete message-contents through a secure user interface. Users can be any authorized persons internal to the provider. The users can access the utility interface 402 through one or more client computers that are in communication with the dynamic messaging application through a suitable network and that host the utility interface 402. In addition to the main message-content creation, deletion, updating and deletion functions, users may additionally be permitted to activate or deactivate specific message-contents, such as message-contents that are applicable on a seasonal basis.

In the factor group lists sub-module 404, users with appropriate permissions can create and/or modify lists of message-contents that are classified or organized according to the various parameters that are received from the incoming request. For example, users can categorize message-contents according to any one of the input request parameters, such as the product type, origin, destination and timing of a trip. In this way, users can be allowed to create reusable message lists, which will be stored in a database for use when messages are dynamically constructed. The factor lists that are created by users can further include lists that are specific to particular users, as well as system-wide lists that can be used by any user. Information stored in messages for system-wide lists may include seasonal or universally-applicable information such as government travel restrictions or warnings to particular destinations, and the like,

The message construction tool 406 is adapted to provide users with the ability to read the incoming request, identify parameters from within the request, and enter or define field associations to trigger a particular dynamic message from a list based on one or more of the values of the incoming parameters. This definition or association of fields with particular messages may be carried out using a formula format such that users may associate multiple potential field entries with one parameter of the incoming message. The below equation is shown as an example of such a parameter definition using a destination data field relating to the airport for the travel destination of the customer who wilt travel by airplane:

If DESTINATION=MIA OR ORD OR JFK, THEN MESSAGE10

In this example, the “destination” parameter indicates the customer's travel destination, as denoted by a standard airport code, is associated with a predetermined message (message 10) when it is indicative that the customer plans to travel to Miami (MIA), Chicago (ORD), or New York City (JFK).

When a request contains one of the field content entries that has been specified in the system, the message construction tool 406 is adapted to initiate the return of a dynamic message, which includes one or more message-contents retrieved according to the rules or equations previously discussed. In the event the message construction tool 406 does not have any rules or equations that apply to a particular parameter, the message construction tool 406 can be configured either to not return a message or to return a default or generic message.

In addition to specifying the content of the return messages provided by the system, the users can also be permitted to select specific periods during which each rule for message-content selection is active. In other words, the users can, in some embodiments, elect to have a rule apply indefinitely, to expire on a certain date, to become active at a certain date, to be active for a set period of time and inactive for another period of time, to cycle between active and inactive periods of time, or to have a rule not apply indefinitely.

The dynamic message construction tool 406 can be adapted to allow users to enter formatted message text that the system will return as a dynamic message. This formatted text will comprise the body of the messages returned by the DMS module 400 as discussed herein. Each message may be simply made up of text, or may additionally include URI, links and images as part or whole of the message-content.

The field association function 408 comprises a utility that allows users to revise message-field associations. In other words, a user can access and display previously defined associations of particular message-contents with message lists and/or incoming request parameters, and revise those associations or add new ones.

The multilingual function 410 can be adapted to allow users to enter message-content in different languages. For example, in some embodiments, a particular message-content can be entered in the language of countries in which the provider's travel insurance products are available or sold, as well as provide user interfaces in multiple languages. In some embodiments, the multilingual function 410 can provide language options that cover each country in which the provider's travel insurance products are offered. In other embodiments, the multilingual function 410 can provide language options in at least some of the languages used in the countries in which the provider's travel insurance products are offered. In some embodiments, the selectable primary language has a default value of English.

In other embodiments, systems and methods for providing dynamic messaging may be implemented on various types of computer architectures, such as for example on a single general purpose computer or workstation, on a networked system, in a client-server configuration, or in an application service provider configuration. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other tangible computer-readable media for use by a computer program.

The computer components, software modules, functions, data stores and data structures described herein may be connected directly or indirectly to each other in order to allow the flow of data needed for their operations. It is also noted that a module or processor can include but is not limited to a unit of code that performs a software operation, and can be implemented, for example, as a subroutine unit of code, a software function unit of code, an object (as in an object-oriented paradigm) or an applet and can be implemented in a computer script language or another type of computer code. The software components and/or functionality (e.g., the travel insurance product quotation and message-content selection functionality) may be located on a single computer or distributed across multiple computers depending upon the particular circumstances surrounding its use (e.g., located on client and/or server computers).

In various embodiments, methods for dynamic messaging in accordance with principles of the present disclosure operate as software programming operating on a computer processor. Dedicated hardware implementations, including, but not limited to, application-specific integrated circuits, programmable logic arrays and other hardware devices, can likewise be constructed to implement the methods described herein. Furthermore, alternative software implementations, including, but not limited to, distributed processing or component/object distributed processing, parallel processing, or virtual machine processing, can also be constructed to implement the methods described herein.

In various embodiments, a dynamic messaging program in accordance with principles of the present disclosure can take the form of a computer program product on a tangible, computer-readable storage medium having computer-readable program code means embodied in the storage medium. Software implementations of the program for dynamic messaging as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be constructed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for dynamic messaging comprising:
a physical computer-readable medium having computer-executable instructions stored thereon, the computer-executable instructions comprising a dynamic messaging program including a message-content determining module and a product price calculating module;
a processor adapted to execute the dynamic messaging program contained on the physical computer-readable medium; and
a web-enabled interface operably arranged with the processor, the web-enabled. interface adapted to exchange information with a partner site over the interact;
a data storage device operably arranged with the processor, the data storage device containing a plurality of message-contents relating to a plurality of travel insurance products;
wherein the product price calculating module includes computer executable instructions adapted to calculate a price quotation for a travel insurance product based upon information received from the partner site through the web-enabled interface, the information relating to a travel product selected on the partner site by a customer, and the message-content determining module includes computer executable instructions adapted to select, based upon the information relating to the travel product selected on the partner site by the customer, at least one message-content related to the travel product from the message-contents stored in the data storage device.

2. The system for dynamic messaging of claim 1, wherein the data storage device includes price information for the travel insurance products, and the product price calculating module is adapted to access the price information stored in the storage device and to determine the price quotation using the accessed price information.

3. The system for dynamic messaging of claim 1, wherein the dynamic messaging program includes computer executable instructions adapted to send through the web-enabled interface the price quotation information generated by the product price calculating module and the message-content selected by the message-content determining module to the partner site.

4. The system for dynamic messaging of claim 3, wherein the price quotation information generated by the product price calculating module and the message-content selected by the message-content determining module is combined and sent through the web-enabled interface to the partner site as a message packet.

5. The system for dynamic messaging of claim 1, wherein the dynamic messaging program includes computer executable instructions comprising a utility interface adapted to allow a user to create message-contents through the utility interface and to store the message-contents in the data storage device.

6. The system for dynamic messaging of claim 1, wherein the dynamic messaging program includes computer executable instructions comprising a user interface and a factor group lists sub-module, the factor group lists sub-module adapted to allow a user to create through the user interface a list of message-contents that are classified according to a data field parameter received in the information relating to the travel product selected on the partner site by the customer.

7. The system for dynamic messaging of claim 6, wherein the dynamic messaging program includes computer executable instructions comprising a message construction tool adapted to allow a user through the user interface to identify a data field parameter and create a message-data field parameter association with a value for the data field parameter to trigger a particular dynamic message from the list of message-contents created using the factor group lists sub-module.

8. The system for dynamic messaging of claim 7, wherein the dynamic messaging program includes computer executable instructions comprising a field association function adapted to allow a user to revise the message-data field parameter association.

9. The system for dynamic messaging of claim 1, wherein the dynamic messaging program includes computer executable instructions comprising a user interface and a message construction tool, the message construction tool adapted to allow a user through the user interface to identify a data field parameter and create a message-data field parameter association with a value for the data field parameter to trigger a particular dynamic message from a list of message-contents.

10. The system for dynamic messaging of claim 9, wherein the dynamic messaging program includes computer executable instructions comprising a field association function adapted to allow a user to revise the message-data field parameter association.

11. A method for dynamic messaging comprising:
receiving, through a network including a web-enabled interface, travel product information regarding a travel product selected by a customer on a web platform of a partner;
employing a processor to execute computer-executable instructions stored on a physical computer-readable medium, the computer-executable instructions performing steps comprising:
identifying a travel insurance product from a set of travel insurance products based upon the travel product information received,
generating a quotation for the identified travel insurance product,
selecting a message-content from a set of message-contents stored in a data storage device based upon the travel product information received, and
generating a message packet including the quotation for the identified travel insurance product and the selected message-content; and
transmitting the message packet through the network to the partner.

12. The method for dynamic messaging of claim 11, wherein the computer executable instructions stored on the tangible computer-readable medium perform a step of:
creating a message-content in response to a command transmitted through a user interface, and
storing the created message-content in he data storage device.

13. The method for dynamic messaging of claim 11, wherein the computer executable instructions stored on the tangible computer-readable medium perform a step of:
creating a list of message-contents in response to a command transmitted through a user interface, the list classified according to a data field parameter in the travel product information received.

14. The method for dynamic messaging of claim 13, wherein the computer executable instructions stored on the tangible computer-readable medium perform a step of:
creating a message-data field parameter association with a value for the data field parameter in response to a command transmitted through the user interface to trigger a particular dynamic message from the list of message-contents.

15. The method for dynamic messaging of claim 14, wherein the computer executable instructions stored on the tangible computer-readable medium perform a step of:
revising the message-data field parameter association in response to a command transmitted through the user interface such that the value for the data field parameter triggers a second dynamic message.

16. A method for providing dynamic messaging to advertise a travel insurance policy to a customer having selected a travel product from a partner site, the method comprising:
receiving a request message in a computer system, the request message containing information indicative of parameters of the travel product selected by the customer;
analyzing the request message using a processor of the computer system to execute a dynamic messaging service (DM S) module stored on a physical computer-readable medium to perform the steps of:
identifying the travel insurance product to advertise from a set of travel insurance products based upon at least one parameter of the travel product selected by the customer, and
selecting a message-content from a database of the computer system based on at least one parameter of the travel product selected by the customer;
using the processor to execute a pricing module stored on a physical computer-readable medium to generate a price quotation for the identified travel insurance product;
using the processor to execute instructions stored on a physical computer-readable medium to compile a return message containing at least the selected message-content and the price quotation; and
using the processor to transmit the return message through a web-enabled interface to the partner site.

17. A non-transitory, tangible computer-readable storage medium bearing instructions for dynamic messaging, the instructions, when executing on one or more computing devices, performing the steps of:
identifying a travel insurance product from a set of travel insurance products based upon information received from a partner through a network, the information including at least one parameter of a travel product selected by a customer on a web platform;
generating a quote for the identified travel insurance product;
selecting a message-content from a database of the computer system based on at least one parameter of the travel product selected by the customer; and
compiling a return message containing at least the quote and the message-content.
